(19) United States
(12) Patent Application Publication
(10) Pub. No.: US 2006/0110485 A1
(43) Pub. Date: May 25, 2006

(54) Device for briquetting

(76) Inventor: Hans Ruf, Tussenhausen (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/523,555

(22) PCT Filed: Aug. 2, 2002
(86) PCT No.: PCT/EP02/08630

§ 371 Date: Sep. 12, 2005

(51) Int. Cl. B28B 7/38; A21C 9/04; A01J 21/00; A01J 25/12; A23G 1/20; A23G 1/22; A23G 3/12; A23G 3/16; A23G 3/18; A23P 1/00; A47J 43/20; B28B 21/00; B29C 47/02; B29C 47/04; B29C 47/06; B29C 63/00

(52) U.S. Cl. 425/100

(57) ABSTRACT

An apparatus for making dust or sediment, such as metal grinding sludge, into briquettes, the apparatus having a charging apparatus with a container for loading the material to be pressed. A charging screw is disposed in the container. The charging screw is driven by a screw driving means and forces the material to be pressed out via a container opening. In addition, there is a briquette press, which has a shaping chamber, in which a press ram is displaceable and which has a supply opening to the inlet of the material to be pressed, which is forced out of the container opening, and a closure slide apparatus for closing and opening the end of the shaping chamber. The charging apparatus is in the form of an independent module and is attachable to the briquette press and is thus easily interchangeable.

### BACKGROUND OF THE INVENTION

1. Field of the Invention

This invention relates to an apparatus for making dust or sediment into briquettes.

2. Discussion of Related Art

An apparatus is taught by European Patent Reference EP-B1-0 748 276. The charging screw conveys the material to be pressed directly into the shaping chamber via the container opening and the supply opening. This apparatus is particularly for making old paper and waste paper into briquettes. The known charging apparatus is a component part of the briquette press.

### SUMMARY OF THE INVENTION

It is one object of this invention to provide an apparatus of the type referred to above but which can be used in a more flexible manner.

This object is achieved with features of an apparatus for making briquettes as described in this specification and in the claims.

With various charging apparatuses being attachable, the apparatus according to this invention can be adapted to different waste materials loaded into the briquette press. Also, maintenance work on the charging apparatuses is easier.

According to another embodiment of this invention, a pipe, provided with screen openings, is disposed between the container opening and the supply opening. Consequently, in the case of waste sludge, the moisture parts can be separated from the solid parts, which means that the material to be pressed is extensively dry as it passes into the shaping chamber, where it can then be further compacted. The separated moist substances can be collected and disposed. The ease with which the charging apparatuses can be removed also makes it simple to replace the pipe.

According to another development of this invention, the screen openings are in the form of slots which extend in the longitudinal direction of the pipe or in an inclined manner. Thus the material to be pressed has enough time to dry off during the conveying process.

The attachable charging apparatuses can be developed in various ways. The container of the charging apparatus according to additional embodiments of this invention can thus be either funnel-shaped or box shaped, directly above the bottom of the container where there are at least two feeder screws, which are positioned next to the charging screw and at a specific angle relative to the charging screw, preferably at right angles.

According to another embodiment of this invention, the feeder screws and/or the charging screw each is respectively mounted in an advantageous manner on only one side on the container, which achieves unrestricted conveying of the waste material.

According to another embodiment of this invention, the attachment of the charging apparatus to the briquette press is accomplished by locking connections. Thus charging apparatuses can be attached and removed in a particularly rapid manner.

### BRIEF DESCRIPTION OF THE DRAWINGS

This invention is now described in more detail by way of different embodiments, in view of the drawings, wherein:

FIG. 1 is a side view of an apparatus according to this invention, for making metal grinding sludge into briquettes;

FIG. 2 is a top view of the apparatus shown in FIG. 1; and

FIG. 3 is a top view of another charging apparatus, which is attachable to the briquette press shown in FIGS. 1 and 2.

### DESCRIPTION OF PREFERRED EMBODIMENTS

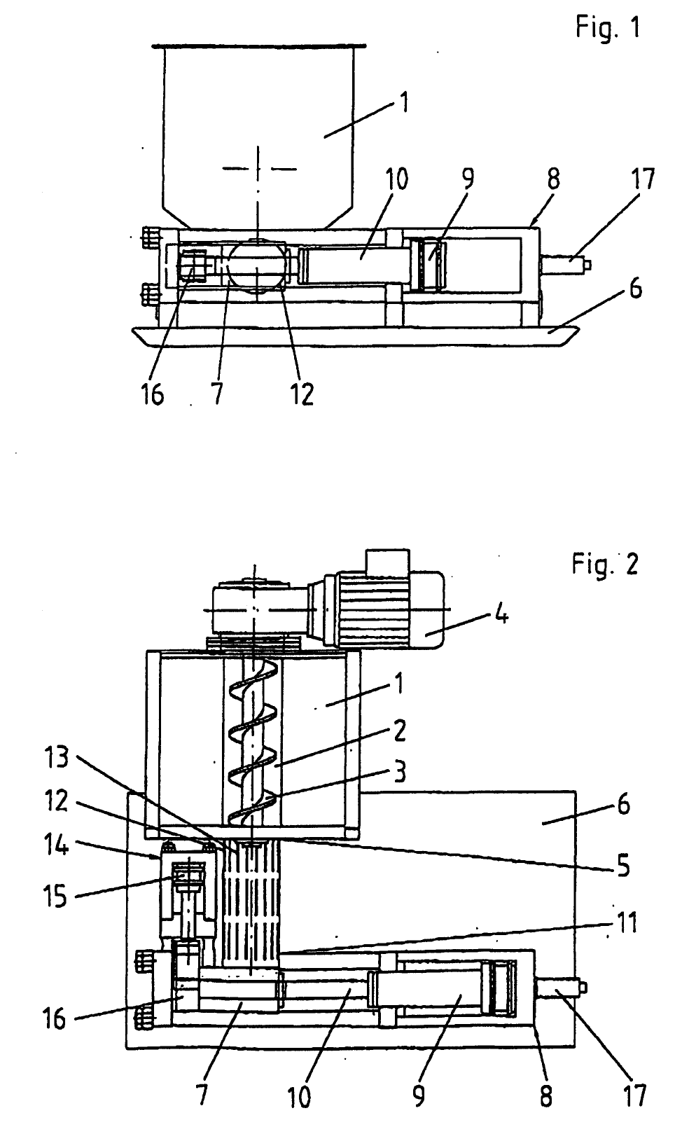

The apparatus shown in FIGS. 1 and 2 has a charging apparatus, which includes a container 1, in the form of a funnel for charging material to be pressed and that opens out into a tank 2. A charging screw 3 is mounted in the tank 2 and is driven by a screw driver or driving means 4. This screw driving means comprises gearing and an electric motor. In the region of or near the charging screw 3 the tank 2 has a container opening 5. This charging apparatus is thus in the form of an independent module.

In addition, the apparatus has a briquette press, which is installed on a base plate 6 and includes a shaping chamber 7 and a cylinder piston unit 8 attached to the shaping chamber 7, the piston 9 of the cylinder piston unit has a press ram 10. The piston 9 is driven by a pneumatic or hydraulic driving means (not represented). The press ram 10, in this case, is moved backwards and forwards in the shaping chamber 7 to make the briquettes. The shaping chamber 7 has a lateral supply opening 11. Between the container opening 5 and the supply opening 11 there is a pipe 12 with screen openings, which are in the form of slots, such as the slot 13. The pipe 12 can be secured to the tank 2 to be easily interchangeable. The container 1 with the charging screw 3 and the screw driving means 4 is disposed to be displaceable in the longitudinal direction of the screw relative to the shaping chamber 7 and to be fixable in position so that different types and lengths of pipes 12 can be used.

In addition, the apparatus has a closure slide apparatus 14, which comprises a cylinder piston unit and a closure slide 16, which is connected to the piston 15 of the cylinder piston unit and closes or respectively opens the end of the shaping chamber 7 situated opposite the press ram 10. The means for driving the piston 15 is pneumatic or hydraulic.

The apparatus also has a displacement pickup 17, which is secured to the cylinder piston unit 8. A variable pressing operation is possible with this displacement pickup. The speed of the press ram is variable in a forward direction and can consequently be adapted to an optimum pressing result. This variable speed can, for example, preferably be achieved with regulatable pumps at a constant speed or with constant pumps with preferably frequency regulated drive motors.

The charging apparatus 1-4, which is formed as an independent module, is mounted on the briquette press 6-17, to be easily interchangeable.

Once the container 1 is charged, the material to be pressed, in this case metal grinding sludge, is forced into the pipe 12 and into the shaping chamber 7 by the charging screw 3 with the closure slide 16 closed. At the same time, the moist substances and gases of the sludge are separated from the rest of the material to be pressed through the screw pressure. The moist substances are discharged via the slots 13 of the pipe 12 and are collected and disposed of in a manner not shown. The screw driving means 4 has a current consumer, which responds before the charging screw 3 becomes blocked and stops the screw driving means 4. The dehydrated material to be pressed in the shaping chamber 7 is then pressed by the press ram to form briquettes, which are forced out once the closure slide 16 is open. With some types of material to be pressed it is advantageous if the pressure is removed from the press ram after the first pressing operation and is then applied once again. This means that it is easier for the residual air or moisture in the briquette, compressed at pressing pressures of up to 5000 kh/m², to dissipate.

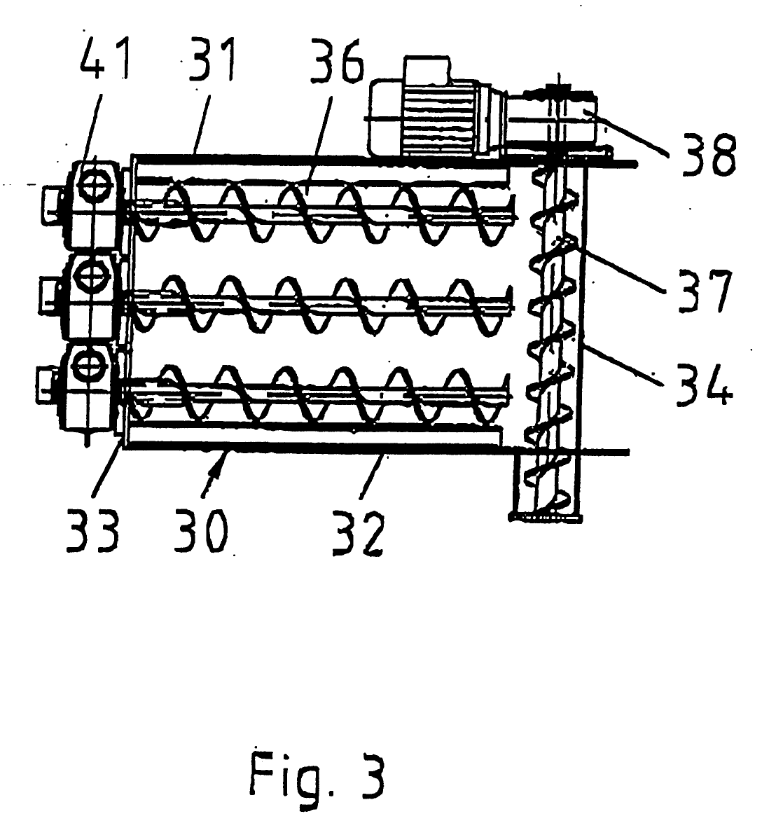

The other charging apparatus 30 shown in FIG. 3 includes a container, having a bottom 36, two side walls 31, 32, a front wall 33 and a rear wall 34 situated opposite the front wall. The side walls 31, 32 and the rear wall 34 are approximately the same height. The front wall 33, however, is kept significantly lower at the point where a container (not shown) with waste material is emptied. Three independent driving means 41 for three feeder screws 40 are secured to the lower front wall 33. The three feeder screws 40 are attached horizontally and parallel to one another above the bottom 36 and are mounted only on the front wall 33. Vertically relative to the longitudinal direction of the feeder screws 40 and at the same height as the feeder screws there is a charging screw 37, which is also attached above the bottom 36, provided with driving means 38 and mounted only on the side wall 31. Deviating from this right-angled disposition of feeder screws and charger screw, it is also possible for them to be disposed at another angle one relative to the other.

The charging apparatus 30 is in the form of an independent module. It can be attached to the briquette press shown in FIGS. 1 and 2 to be easily interchangeable.

The attachment of the charging apparatus 1-4 or respectively 30 to the briquette press is accomplished preferably by locking connections.

When the feeder screws 40 and the charging screw 37 are set in operation, the feeder screws 40 convey the waste material, in the form of, for example, metal shavings, in the direction of the charging screw 37, which takes over the metal shavings and with a change in direction guides them to the briquette press. The metal shavings processed in the briquette press do not need to be reduced into small pieces before being introduced into the charging apparatus 30. There is no agitator required in the charging apparatus 30 to mix the different types of metal shavings. The apparatus is thus in a position to process shavings with different thicknesses and lengths, metal shaving balls, etc., without any preliminary processing.

As mentioned, the feeder screws 40 and the charging screw 37 have separate driving means. With these separate driving means it is possible, in the event of the metal shavings being unevenly distributed on the bottom 36 of the charging apparatus 3, to operate one feeder screw and to stop another feeder screw. The adjustment of the independent operation of the individual feeder screws 40, the interaction of the speeds of the feeder screws 40 in the case of forward rotation or respectively backward rotation, the dependence of the operation of the screw 40, 37 on the resistance of the waste material to be processed etc. are controlled by programming units, which are generally known and are not objects of this invention. These programming units, however, can also have different programs which include specific characteristics or characteristics that differ greatly from each other.

1. An apparatus for making dust or sediment, such as metal grinding sludge, into briquettes, the apparatus having a charging apparatus with a container for loading the material to be pressed, a charging screw disposed in the container, the charging screw driven by a screw driver and forcing the material to be pressed out via a container opening, and the apparatus having a briquette press which has a shaping chamber in which a press ram is displaceable and which has a supply opening to an inlet of the material to be pressed which is forced out of the container opening, and a closure slide apparatus for closing and opening an end of the shaping chamber, the apparatus comprising the charging apparatus (1-4; 30) having a form of an independent module and attachable to the briquette press in an interchangeable manner.

2. The apparatus according to claim 1, wherein a pipe (12) having screen openings (13) is disposed between a container opening (5) and the supply opening (11).

3. The apparatus according to claim 2, wherein the screen openings are slots (13) which extend in a longitudinal direction of the pipe.

4. The apparatus according to claim 3, wherein the container (1) is funnel-shaped.

5. The apparatus according to claim 3, wherein the container (31-34, 36) is box-shaped and directly above a bottom (36) of the container there are at least two feeder screws (40) disposed next to the charging screw (37) and at an angle relative to the charging screw.

6. The apparatus according to claim 5, wherein at least one of the feeder screws (40) and the charging screw (37) each is mounted on one side on the container (30).

7. The apparatus according to claim 6, wherein an attachment of the charging apparatus (1-4; 30) to the press (6-17) is a locking connection.

8. The apparatus according to claim 1, wherein the container (1) is funnel-shaped.

9. The apparatus according to claim 1, wherein the container (31-34, 36) is box-shaped and directly above a bottom (36) of the container there are at least two feeder screws (40) disposed next to the charging screw (37) and at an angle relative to the charging screw.

10. The apparatus according to claim 9, wherein at least one of the feeder screws (40) and the charging screw (37) each is mounted on one side on the container (30).

11. The apparatus according to claim 1, wherein an attachment of the charging apparatus (1-4; 30) to the press (6-17) is a locking connection.
